(19) United States
(12) Patent Application Publication
(10) Pub. No.: US 2007/0175311 A1
(43) Pub. Date: Aug. 2, 2007

(54) MULTI-FINGER GUITAR SLIDE

(76) Inventor: Michael Sloan, Colgate, WI (US)

Correspondence Address: ANDRUS, SCEALES, STARKE & SAWALL, LLP, 100 EAST WISCONSIN AVENUE, SUITE 1100, MILWAUKEE, WI, 53202, US

(21) Appl. No.: 11/668,579

(22) Filed: Jan. 30, 2007

Related U.S. Application Data
(60) Provisional application No. 60/763,228, filed on Jan. 30, 2006.

(51) Int. Cl. G10D 3/00

(52) U.S. Cl. 84/315

(57) ABSTRACT

A multi-finger guitar slide for permitting a musical instrument player to contact individual strings of a stringed instrument at different locations. The multi-finger guitar slide includes a glove having multiple fingers that can be worn over the player's hand. Each of the fingers of the glove includes a slide member aligned with the fingertip of the user when the glove is worn. Each of the slide members is removably secured to the glove and has a width less than the width across the plurality of strings of the stringed instrument. Each of the slide members can be formed from one of multiple different materials and the individual slide members can be removed and replaced as desired.

### CROSS-REFERENCE TO RELATED APPLICATION

The present application is based on and claims priority to U.S. Provisional Patent Application Ser. No. 60/763,228, filed on Jan. 30, 2006.

### BACKGROUND OF THE INVENTION

The present invention generally relates to an apparatus for use in playing a guitar. More specifically, the present invention relates to an apparatus that can be used when playing a guitar to create a slide to different frets and chord formations.

Presently, devices exist that allow a guitar player to create a unique sound referred to as a “slide”. Typically, these devices include a slide member that the player positions across the entire width of the guitar neck and in contact with each of the typically six strings of the guitar. As the slide member is slid along the length of strings, the slide member creates the unique sound referred to as a slide. Presently available slide members are typically worn over a single finger of the guitar player and simultaneously contact all of the strings of the guitar. The current design allows the player to only create a single fret slide.

Therefore, it is an object of the present invention to provide a device that allows for a guitar player to apply a slide to different frets and chord formations. Further, it is an object of the invention to provide an apparatus that can be easily applied to the guitar player's hand and removed when desired.

### SUMMARY OF THE INVENTION

The present invention is a multi-finger guitar slide that can be used by a musical instrument player to apply the classic southern rock concept of a slide to different frets and chord formations. The present invention is an improvement over conventional cylindrical guitar slides that contact all of the strings of the musical instrument, such as the six strings of a guitar.

The multi-finger guitar slide includes a glove that is similar in design to athletic-style gloves. Preferably, the thumb covering of the glove is eliminated to provide additional gripping ability for the musical instrument player. The glove is made from a material that will either eliminate or minimize perspiration during use, such as leather or a synthetic-leather material.

Each finger of the glove includes a slide member positioned on the outer digit of the finger past the outer knuckle. Each slide member is permanently or removably affixed to the fingertip of the glove finger and is in contact with the player's finger pad. The slide members are formed from a smooth, curved material such as glass, metal, plastic or another similar material. Each slide member will enable the player to play different frets and bend notes at the same time (multiple strings at different intervals) to create the sound of a classic rock slide.

In one embodiment of the invention, each of the slide members is permanently affixed to the fingertip of one of the glove fingers, such as by an adhesive. Alternatively, in another contemplated embodiment, each glove fingertip section includes a first attachment member while each of the slide members includes a second attachment member. The first and second attachment members interact with each other to secure the slide member to the fingertip section of one of the fingers of the glove. The interaction between the first and second attachment members allows the individual slide members to be removed and replaced as desired by the musical instrument player. Additionally, the ability to remove each of the slide members allows the player to selectively include slide members formed from different materials. As an example, one or more of the slide members may be formed from glass while other slide members may be formed from a metallic material, such as brass. The ability to selectively mix the material of the slide members allows the player to develop different sounds as desired.

Each of the slide members on the fingertips of the glove will be small as to where each slide member will contact only one string. The slide members also are rounded to produce the sound made from a normal guitar slide. Each slide member is positioned on the upper-most digit of the player's fingertip, typically aligned with the finger pad, where the player's fingers naturally hit the fret.

Preferably, the glove will have no thumb since the player's thumb is used to grip the rear of the guitar neck when a guitar is being played. Preferably, the glove will be made from a slip-proof material similar to the material used to make a batting glove in baseball. The selection of the material will make it easier to take the multi-finger guitar slide on and off for solos or different sections of a song.

### BRIEF DESCRIPTION OF THE DRAWINGS

In the drawings:

FIG. 1 is a front view of a multi-finger guitar slide;

FIG. 2 is a magnified view of the individual fingers and slide members of the multi-finger guitar slide;

FIG. 3 is a view of a guitar player utilizing the multi-finger guitar slide;

FIG. 4 is a magnified view illustrating the position of the guitar player's fingers on the individual strings of the guitar;

FIG. 5 is a front view of the multi-finger guitar slide that includes removable attachment members to attach each of the individual slide members; and

FIG. 6 is a section view taken along line 6-6 of FIG. 5.

### DETAILED DESCRIPTION OF THE INVENTION

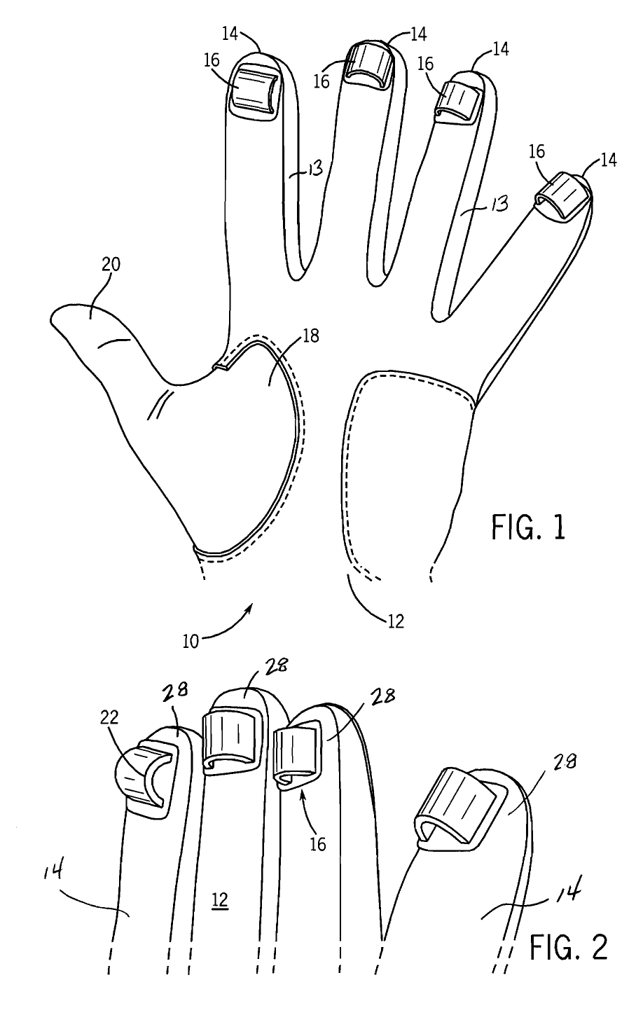

FIG. 1 illustrates the multi-finger guitar slide of the present invention. The guitar slide 10 generally includes a glove 12 having multiple, individual fingers 14 each including a separate slide member 16 attached to the glove and positioned in alignment with the outer digit of the player's finger. In the preferred embodiment of the invention, the glove 12 will be similar to an athletic-style glove, such as a batter's glove or golf glove, and will be formed from a material that will either eliminate or minimize perspiration during use. As an example, leather or synthetic leather-type materials that include venting areas 13 between the fingers are contemplated as being a preferred embodiment of the invention.

In the embodiment of the invention illustrated in FIG. 1, the glove 12 includes a removed area 18 that allows the player's thumb 20 to be free to grip the guitar during playing. However, the glove 12 could also cover the thumb 20, depending upon the player's preference.

Referring now to FIG. 2, each of the slide members 16 is preferably formed from a smooth material having an arcuate outer contact surface 22. In the embodiment of the invention illustrated, each of the slide members 16 is formed from glass, although other materials such as metal or molded plastic are contemplated as being within the scope of the present invention. As discussed previously, each slide member 16 is aligned with the upper-most digit of the player's fingertip when the glove 12 is worn, which is the portion of the finger that contacts the fret during normal play.

In the embodiment illustrated in FIG. 2, each of the slide members 16 is permanently adhered to the glove 12 using an adhesive material. It is contemplated that the slide members 16 could be attached to the fingertip sections 28 in any known manner that allows the player to manipulate his or her fingers during the playing of the guitar.

In the preferred embodiment of the invention, each of the slide members 16 has an arcuate outer contact surface 22 that allows the slide member 16 to have an overall height of only about one or two millimeters. The slide member 16 can be formed from various materials, such as glass, steel, brass, copper, ceramic, porcelain, plastic or other similar type of material. The selection of the various different materials allows the player to create different sounds utilizing the guitar slide 10. As an example, the selection of slide members 16 formed from glass will generate a different sound than slide members 16 formed from metal, such as either brass or copper. It is contemplated that the player could own multiple multi-finger guitar slides 10 where one of the guitar slides 10 would include slide members formed from a first material, such as glass, while another guitar slide 10 would include slide members 16 formed from a second material, such as brass. Since the multi-finger guitar slides 10 can be easily removed from the player's hand, if the player desired a different sound during a performance, the guitar slide 10 that produces the required sound would be selected and placed over the player's hand.

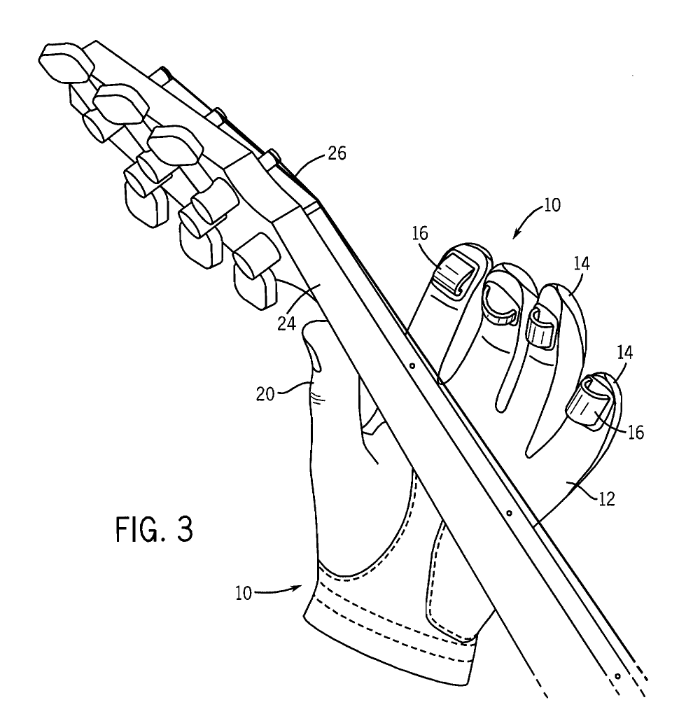

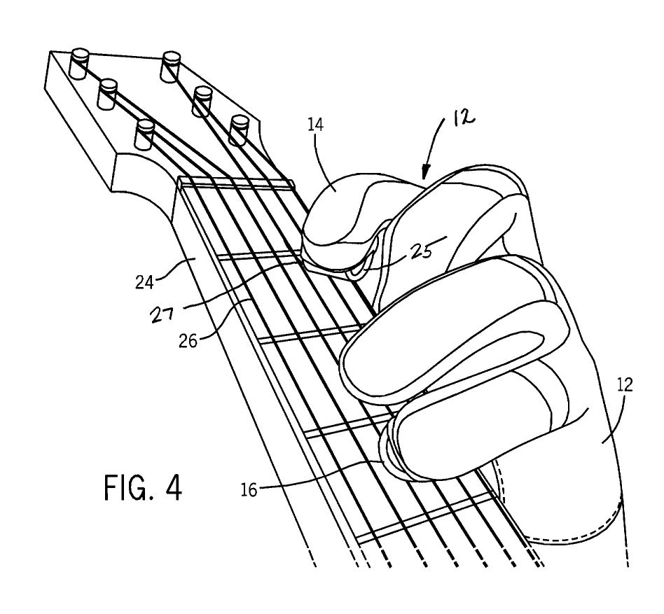

Referring now to FIG. 3, thereshown is the multi-finger guitar slide 10 in use by the player of a guitar. As illustrated, the thumb 20 contacts the back surface of the guitar neck 24 while the individual fingers 14 are used to contact the individual strings 26 of the guitar. As best shown in FIG. 4, the slide member 16 of each individual finger can be brought into contact with different strings 26, which allows the guitar player to play different frets and bend notes at the same time. In the embodiment shown in FIG. 4, each of the slide members 16 has a width from the first side 25 to the second side 27 that is substantially less than the width of the guitar neck 24. Specifically, the width of each of the slide members 16 is significantly less than the distance between the two outermost strings 26 such that each of the slide members 16 can cover only one or two of the typical six strings of a guitar. Thus, each individual slide member 16 cannot be utilized, by itself, to create a slide over all of the six strings shown.

When the player's hand is positioned as shown in FIG. 4, the player can slide the multiple slide members 16 along the individual strings 26 to create a classic rock slide sound. However, since each of the fingers 14 are located on different strings and frets, the multi-finger guitar slide 10 allows the player to create sounds that were previously unavailable by utilizing conventional slide members.

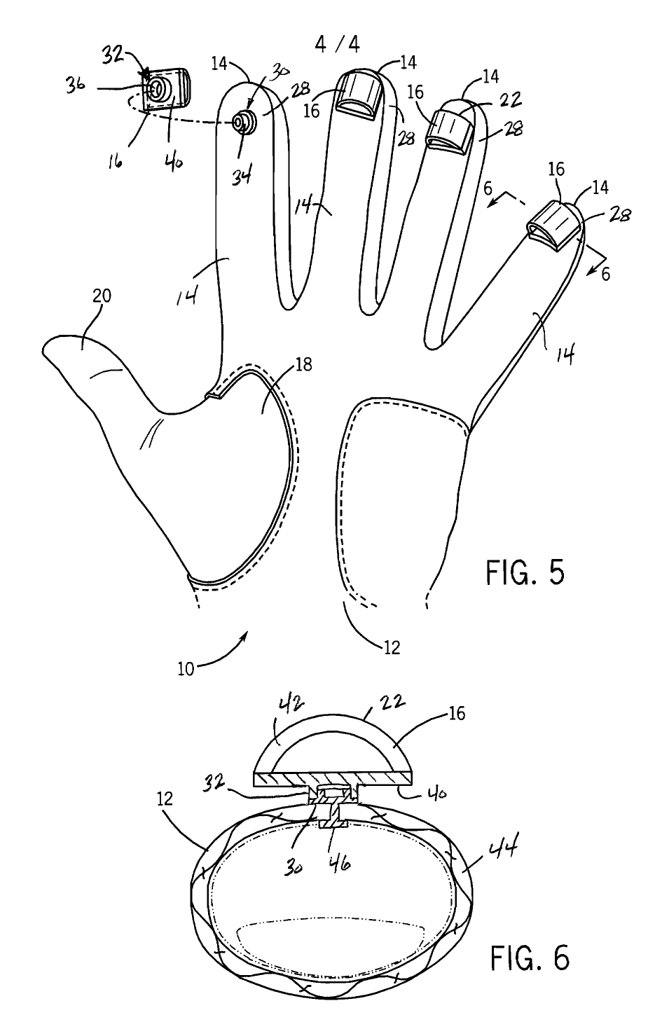

FIG. 5 illustrates a second, alternate embodiment of the multi-finger guitar slide 10. As with the first embodiment shown in FIG. 1, the multi-finger guitar slide 10 includes a glove 12 having individual fingers 14 such that the glove can be worn on the hand of a player. The multi-finger guitar slide 10 includes the individual slide members 16 each positioned on the fingertip section 28 of each finger. However, unlike the embodiment shown in FIG. 1, each of the slide members 16 is selectively removable from the fingertip section 28.

As illustrated in FIG. 5, the fingertip section 28 of each finger 14 includes a first attachment member 30 while the slide member 16 includes a second attachment member 32. The interaction between the first and second attachment members 30, 32 allow each of the slide members 16 to be securely held on one of the fingertip sections 28. Further, the interaction between the first and second attachment members 30, 32 allow each of the individual slide members 16 to be selectively removed and replaced from the multi-finger guitar slide 10. In this manner, the user can select different slide members 16 from a group of slide members formed from various different materials, such as glass, steel, brass, copper, ceramic, porcelain, plastic or other similar type of material. The removable mounting of the slide members 16 allows all of the slide members 16 to be replaced by slide members 16 of a different material or the selective replacement of only several of the slide members 16. As an example, the user could select the slide members on the index and middle finger to be made from glass, while the slide members 16 attached to the ring and pinkie fingers could be formed from a metallic material, such as brass. As can be understood, the selection of each of the individual slide members 16 can be any one of a large number of combinations depending upon the user requirement.

In addition to the ability to remove each of the slide members 16, the interaction between the first and second attachment members 30, 32 allow each of the slide members 16 to be rotated relative to the finger of the player. In the embodiment shown in FIG. 5, each of the slide members 16 has the same orientation such that the arcuate contact surface 22 extends across the player's finger. However, each of the slide members could be rotated 90° such that the arcuate contact surface 22 would extend parallel to the length of the finger 14.

In the embodiment shown in FIG. 5, the first attachment member 30 is a male snap member having a protruding center post 34 that is received within an internal cavity 36 formed as part of a female snap member contained on the slide member 16. The internal cavity 36 is defined by an outer wall 38 that protrudes from a generally planar back wall 40.

As illustrated in FIG. 6, the slide member is shown as including a curved outer wall 42 that defines the arcuate contact surface 22. The curved outer wall 42 is connected to the back wall 40, which in turn includes the second attachment member 32. The first attachment member 30 extends through the material 44 of the glove 12 and includes an expanded head 46 that holds the first attachment member in place.

Although a specific embodiment of the first and second attachment members 30, 32 is shown in FIGS. 5 and 6, it is contemplated that other embodiments could be utilized while falling within the scope of the present invention. As an example, it is contemplated that the first and second attachment members 30, 32 could be replaced by Velcro strips or some type of latching mechanism that would allow the slide members 16 to be securely held in place along each of the fingers 14 while still being removable as described.

As described above, the multi-finger guitar slide includes multiple individual slide members that are each positioned along a different finger of the guitar player. Each of the slide members can be positioned on different strings and frets, thus allowing the guitar player to create a slide sound that was previously unavailable. Preferably, each of the slide members is formed from a hard material, such as metal, plastic or glass having a size small enough to allow the guitar player to position the slide member in contact with only a single string of the guitar.

I claim:

1. A multi-finger guitar slide to be worn on a hand of a musical instrument player comprising:
a glove having a plurality of fingers adapted to be worn over the hand of the player; and
a plurality of individual slide members each attached to one of the plurality of fingers of the glove.

2. The guitar slide of claim 1 wherein the glove includes a removed area such that the glove does not cover a thumb of the player.

3. The guitar slide of claim 1 wherein each of the slide members is formed from one of a group of materials including glass, steel, brass, copper, ceramic, porcelain and plastic.

4. The guitar slide of claim 3 wherein each of the plurality of slide members may be formed from different material from other of the slide members.

5. The guitar slide of claim 1 wherein each slide member includes an arcuate outer contact surface.

6. The guitar slide of claim 1 wherein each finger of the glove includes a finger tip section, each of the slide members being attached to the finger tip section.

7. The guitar slide of claim 1 wherein the glove is formed from leather or synthetic leather.

8. The guitar slide of claim 1 wherein each of the slide members is attached to one of the fingers by an adhesive.

9. The guitar slide of claim 5 wherein the arcuate outer contact surface of each of the slide members has a width less than the distance across all of the strings of a guitar.

10. A multi-finger guitar slide to be worn on a hand of a musical instrument player comprising:
a glove having a plurality of fingers and adapted to be worn on the hand of the player, each finger including a finger tip section; and
a plurality of slide members each removably attached to the finger tip section of one of the plurality of fingers of the glove.

11. The guitar slide of claim 10 further comprising:
a plurality of first attachment members each positioned on one of the fingertip sections of the glove; and
a plurality of second attachment members each associated with one of the slide members, wherein the first and second attachment members interact to attach each of the slide members to the glove.

12. The guitar slide of claim 11 wherein the interaction of the first attachment member and the second attachment member permits rotation of the slide member relative to the finger.

13. The guitar slide of claim 11 wherein the first attachment member is a male snap member and the second attachment member is a female snap member.

14. The guitar slide of claim 10 wherein the glove includes a removed area such that the glove does not cover a thumb of the player.

15. The guitar slide of claim 11 wherein each of the slide members is formed from one of a group of materials including glass, steel, brass, copper, ceramic, porcelain and plastic.

16. The guitar slide of claim 15 wherein each of the slide members may be formed from different materials from other of the slide members.

17. The guitar slide of claim 10 wherein each slide member includes an arcuate outer contact surface.

18. The guitar slide of claim 17 wherein the arcuate outer contact surface of each slide member has a width less than the distance across all of the strings of a guitar.
